(19) United States
(12) Patent Application Publication
(10) Pub. No.: US 2023/0111635 A1
(43) Pub. Date: Apr. 13, 2023

(54) FLOATING SOCKET CONNECTOR

(71) Applicant: Molex, LLC, Lisle, IL (US)

(72) Inventors: Chiuming LU, Lisle, IL (US); Ronald C. HODGE, Montgomery, IL (US); Pierre PEREZ, Aurora, IL (US)

(73) Assignee: Molex, LLC, Lisle, IL (US)

(21) Appl. No.: 18/079,118

(22) Filed: Dec. 12, 2022

Related U.S. Application Data
(63) Continuation of application No. 17/120,294, filed on Dec. 14, 2020, now Pat. No. 11,527,842.
Application No. 17/120,294 is a continuation of application No. 16/330,767, now Pat. No. 10,892,576.
(60) Provisional application No. 62/423,285, filed on Nov. 17, 2016.
(60) Provisional application No. 62/428,753, filed on Dec. 1, 2016.
(60) Provisional application No. 62/450,641, filed on Jan. 26, 2017.
(60) Provisional application No. 62/460,323, filed on Feb. 17, 2017.
(60) Provisional application No. 62/504,827, filed on May 11, 2017.

(51) Int. Cl. H01R 12/91; H01R 13/187; H01R 13/631; H01R 25/16

(52) U.S. Cl. CPC H01R 12/91; H01R 13/187; H01R 13/6315; H01R 25/162; H01R 12/7088

(57) ABSTRACT

A socket connector is configured to mount to a component, such as a printed circuit board. The socket connector includes a base having a passageway and a channel extending outwardly from the passageway, a barrel including a wall having a flange extending outwardly therefrom, at least one biasing member engaging the flange and surrounding the wall, and a contact seated within the barrel. The wall is seated within the passageway and the flange is seated within the channel. The barrel is configured for movement within the base to align a centerline of a pin inserted into the socket connector with a centerline of the hole of the component.

### RELATED APPLICATIONS

This application is a continuation of U.S. Application No. 17/120,294, filed on Dec. 14, 2020, which is a continuation of U.S. Application No. 16/330,767, filed on Mar. 06, 2019, which claims priority to PCT Application No. PCT/US2017/061910, filed on Nov. 16, 2017, which further claims the domestic priority of U.S. Provisional Application Serial No. 62/423,285, filed on Nov. 17, 2016, U.S. Provisional Application Serial No. 62/428,753, filed on Dec. 1, 2016, U.S. Provisional Application Serial No. 62/450,641, filed Jan. 26, 2017, U.S. Provisional Application Serial No. 62/460,323, filed on Feb. 17, 2017, and U.S. Provisional Application Serial No. 62/504,827, filed May 11, 2017. The contents of each of the aforementioned Applications are incorporated herein in their entireties.

### TECHNICAL FIELD

This disclosure relates to the field of connectors, more specifically to board mounted and bus mounted power connectors.

### BACKGROUND ART

Power connectors are used in equipment consuming high amounts of power and consequently utilize high current. In some instances, multiple connectors are mounted on printed circuit boards and bus bars in an array. In larger arrays of power connectors, alignment of a male pin to a female socket connector may be difficult due to a buildup of tolerances. High power systems can also generate heat and the resultant expansion of the system when carrying high current can cause relative movement between the male pin and the female socket connector.

### SUMMARY

A socket connector is configured to mount within a hole in a component, such as a printed circuit board. The socket connector includes a base, a passageway extending therethrough and a channel extending outwardly from the passageway, a barrel including a wall having a passageway therethrough and a flange extending outwardly from the wall, at least one biasing member engages the flange and surrounding the wall, and a contact seated within the passageway of the barrel. The wall of the barrel is seated within the passageway of the base and the flange of the barrel is seated within the channel of the base. The barrel is configured for movement within the base to align a centerline of a pin inserted into the socket connector with a centerline of the hole of the component.

### BRIEF DESCRIPTION OF THE DRAWINGS

The present invention is illustrated by way of example and not limited in the accompanying figures in which like reference numerals indicate similar elements and in which:

FIG. 1 depicts a perspective view of an embodiment of a socket connector;

FIG. 2 depicts a side elevation view of the socket connector;

FIG. 3 depicts an exploded perspective view the socket connector;

FIG. 4 depicts a perspective view of another embodiment of a socket connector;

FIG. 5 depicts a side elevation view of the socket connector of FIG. 4;

FIG. 6 depicts a side elevation view of the socket connector of FIG. 4 engaged with a pin;

FIGS. 7-10 depict cross-sectional views of embodiments of the socket connector engaged with a component, such as a printed circuit board;

FIG. 11 depicts a side elevation view of a base of the socket connector of FIG. 1;

FIG. 12 depicts a side elevation view of a barrel of the socket connector of FIG. 1;

FIG. 13 depicts a perspective view of a contact of the socket connector;

FIG. 14 depicts a side elevation view of the contact;

FIG. 15 depicts an end elevation view of the contact;

FIG. 16 depicts a cross-sectional view of two socket connectors mounted to component, such as bus bars and printed circuit boards, by a pin;

FIG. 17 depicts an end elevation view of the socket connector having a pin mounted therein;

FIG. 18 depicts a perspective view of an alignment tool used to surface mount the socket connector onto the component; and

FIG. 19 depicts a cross-sectional view of the socket connector, the component and the alignment tool.

### DETAILED DESCRIPTION OF THE PREFERRED EMBODIMENTS

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

A floating socket connector 20, when used with a pin 200 mounted within the socket connector 20, connects components 300 together to form an electrical connection. For example, the socket connector 20, when used with the pin 200, may be used to connect a printed circuit board or flex circuit to a bus bar or pair of bus bars which may be arranged in a parallel fashion, or may be used to connect a first printed circuit board or flex circuit to a second printed circuit board or flex circuit. In an embodiment, the socket connector 20 is a power connector. As can be appreciated from the figures, the socket connector 20 provides a floating connection configuration. By “floating connection configuration”, this means that the socket connector 20 and the pin 200 can move relative to each other. This floating design allows a certain degree of misalignment between the socket connector 20 and the pin 200 and the socket connector 20 automatically compensates for the misalignment while maintaining electrical contact.

The pin 200 is conventional and is formed of a body 202 having opposite ends 202a, 202b and an outer surface 202d which defines an outer diameter. A centerline 204 of the pin 200 is provided along the length of the pin 200 between the ends 202a, 202b and defines a longitudinal axis.

The components 300 are conventional. Each component 300 has first and second surfaces 300a, 300b and a through hole 302 therethrough in which the floating socket connector 20 may be mounted. A centerline 304 of the through hole 302 is provided along the height of the component 300 between the surfaces 300a, 300b and defines a longitudinal axis. In an embodiment, the first and second surfaces 300a, 300b are planar.

The socket connector 20 includes a base 30, a contact assembly 32 mounted within the base 30, and at least one biasing member 34. All components of the socket connector 20 are formed of a conductive material, such as metal. The base 30 is affixed to the component 300 as described herein. The contact assembly 32 is configured to move relative to the base 30 and thus, relative to the component 300 to which the base 30 is affixed.

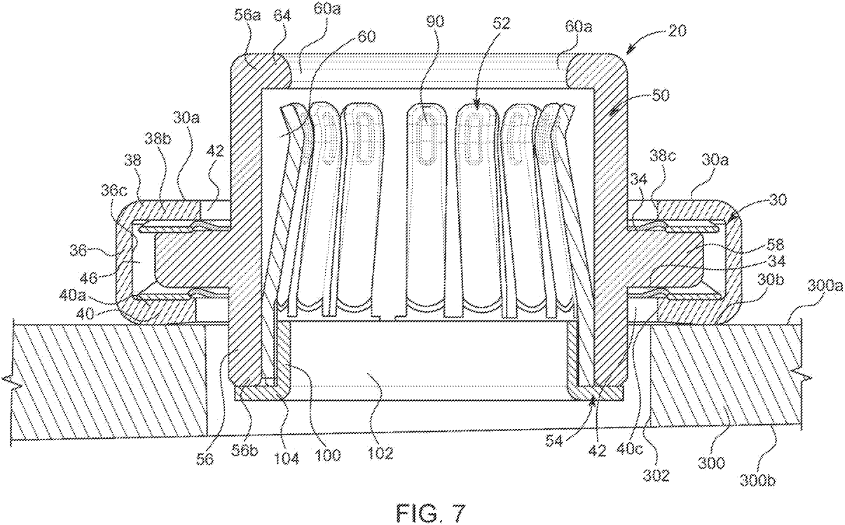

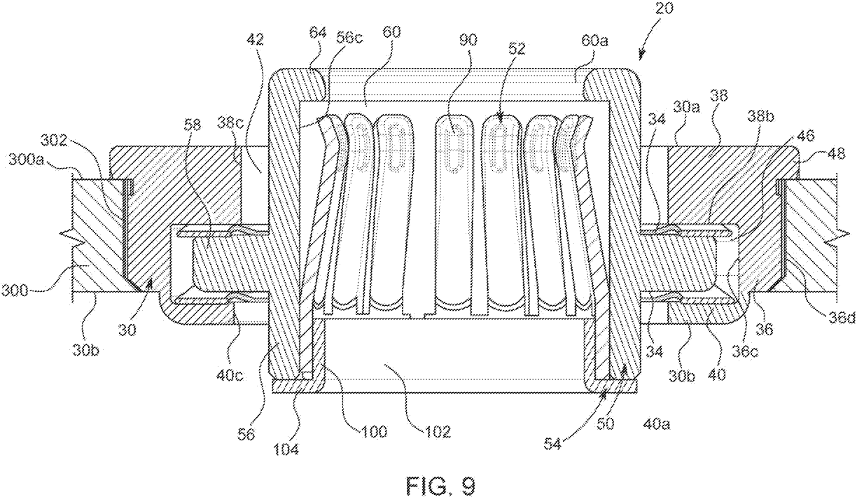

In an embodiment as shown in FIGS. 7-9, the base 30 is annular and has a generally U-shaped cross-section. The base 30 includes a vertical outer wall 36, a first wall 38 extending inwardly from an end of the outer wall 36, and a second wall 40 extending inwardly from the opposite end of the outer wall 36. In some embodiments, the first and second walls 38, 40 are perpendicular to the vertical outer wall 36. Inner surfaces 38c, 40c of the first and second walls 38, 40 form a passageway 42 therethrough which extends from a first end 30a of the base 30 to a second end 30b of the base 30. A centerline 44 of the base 30 is provided along the length of the base 30 between the ends 30a, 30b and defines a longitudinal axis. Surfaces 36c, 38b, 40a of the outer wall 36, the first wall 38 and the second wall 40, respectively, form a channel 46 which is in communication with and extends outwardly from the passageway 42. The channel 46 has a height which extends in the same direction as the centerline 44 which is less than the height of the passageway 42 which extends in the same direction as the centerline 44. In an embodiment, the surfaces 38b, 40a of the channel 46 are parallel to each other and surface 36c is perpendicular to the surfaces 38b, 40a. In an embodiment, the channel 46 is proximate to, but spaced from, the second end 30b of the base 30. In some embodiments, the walls 36, 38, 40 are annular such that the passageway 42 and the channel 46 are provided in a cylindrical configuration.

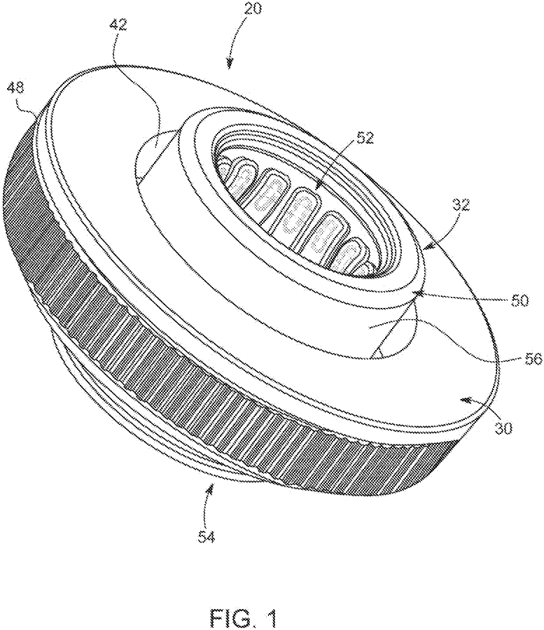

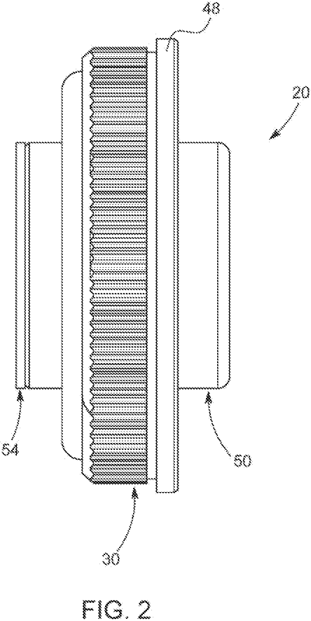

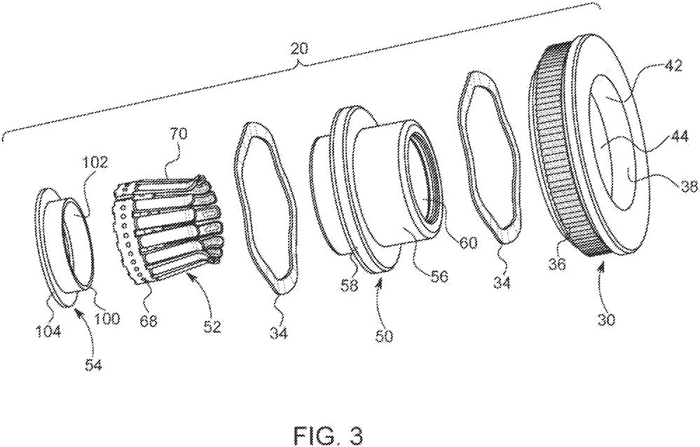

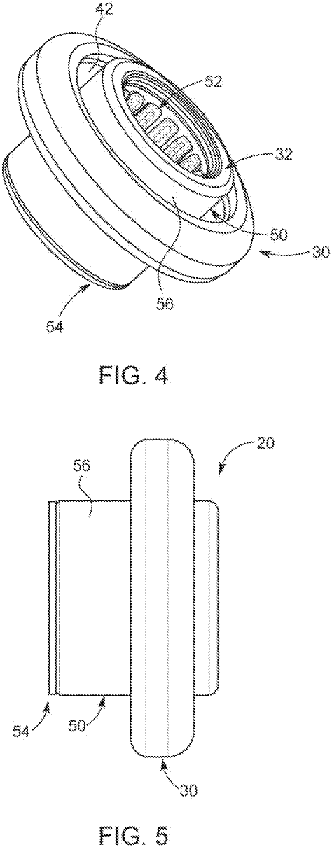

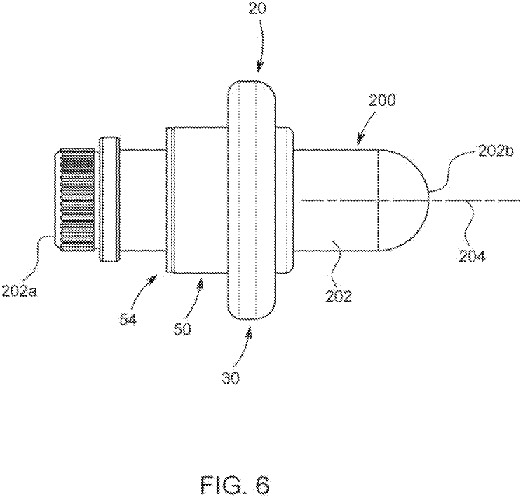

In some embodiments as shown in FIGS. 1, 2, 9 and 11, an outer surface 36d of the outer wall 36 has serrations thereon.

In some embodiments as shown in FIGS. 1, 2, 9 and 11, a lip 48 extends outwardly from the outer surface 36d of the outer wall 36 proximate to the first end 30a.

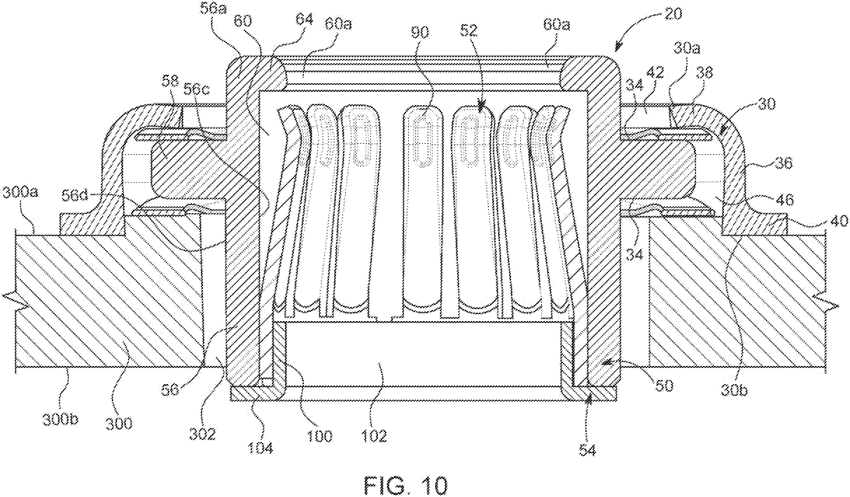

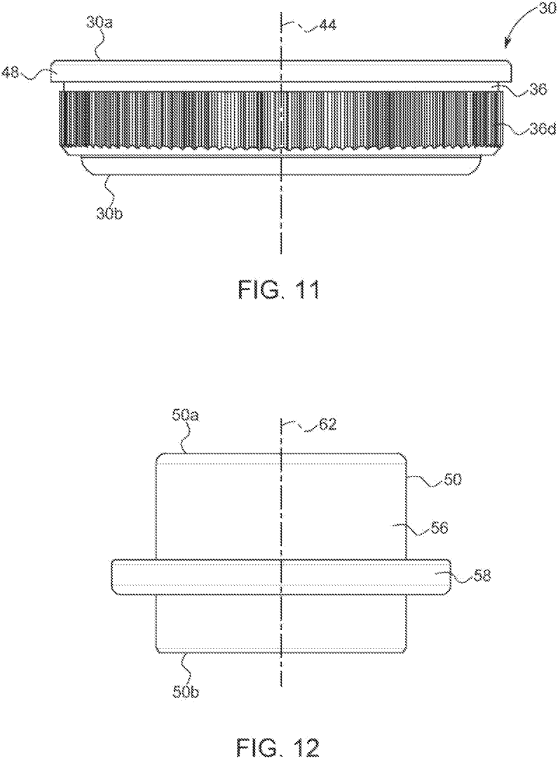

In an embodiment as shown in FIG. 10, the second wall 40 extends outwardly from the outer wall 36 instead of inwardly. As a result, the channel 46 is open to the second end 30b of the base 30.

The contact assembly 32 includes a barrel 50, a contact 52 and a cap 54.

The barrel 50 is formed of a vertical wall 56 and a flange 58 extending outwardly from an outer surface 56d of the vertical wall 56. An inner surface 56c of the wall 56 forms a passageway 60 which extends from a first end 50a of the barrel 50 to a second end 50b of the barrel 50. A centerline 62 of the barrel 50 is provided along the length of the barrel 50 between the ends 50a, 50b thereof and defines a longitudinal axis.

In some embodiments, the wall 56 and the flange 58 have a circular cross-section. The flange 58 can be provided at any position along the outer surface 56d of the wall 56. As shown in the drawings, the flange 58 is provided proximate to, but spaced from, a first end 56a of the wall 56.

In some embodiments as shown in FIGS. 7, 9 and 10, a flange 64 extends inwardly from an inner surface 56c of the wall 56, is spaced from the flange 58, and restricts the passageway 60. In an embodiment, the flange 64 extends inwardly from the wall 56 at the first end 56a of the wall 56, thereby restricting a first end 60a of the passageway 60. In some embodiments, the flange 64 is annular. The flange 64 may be eliminated

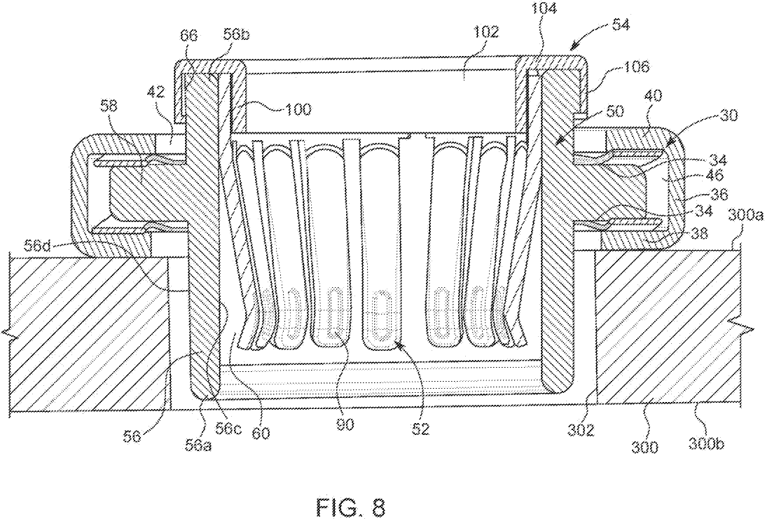

In some embodiments as shown in FIG. 8, a flange 66 extends outwardly from the outer surface 56d and is spaced from the flange 58. In an embodiment, the flange 66 extends outwardly from the wall 56 at the second end 56b of the wall 56. In some embodiments, the flange 66 is annular. The flange 66 may be eliminated.

The contact 52 generally forms a hollow shape which generally conforms to the shape of the inner surface 56c of the wall 56 of the barrel 50. The contact 52 may be formed of an alloy with gold plating.

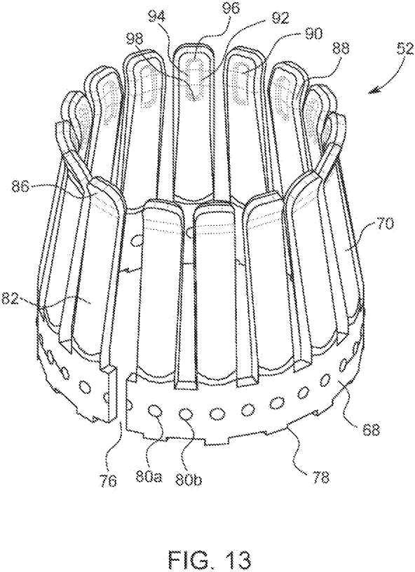

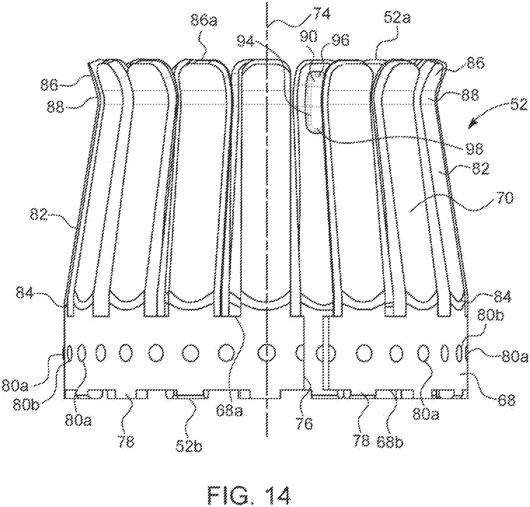

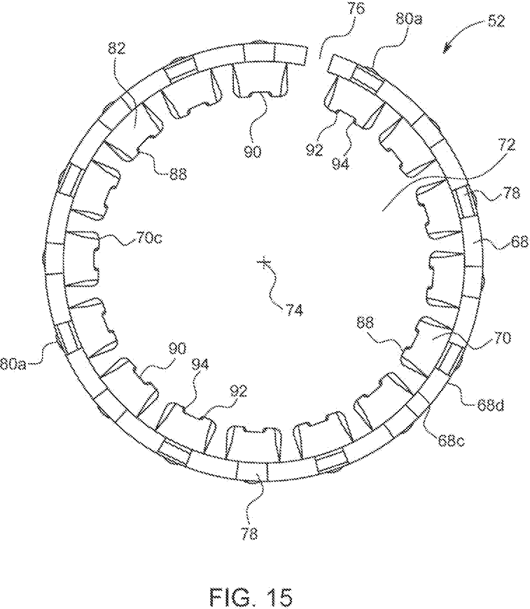

In an embodiment, as shown in FIGS. 13-15, the contact 52 is formed from a ring-like connecting portion 68 having a plurality of separate flexible beams 70 cantilevered therefrom such that a passageway 72 is formed therein which extends from a first end 52a of the contact 52 to a second end 52b of the contact 52. A centerline 74 of the contact 52 is provided along the length of the contact 52 between the ends 52a, 52b and defines a longitudinal axis.

The connecting portion 68 has first and second ends 68a, 68b, an inner surface 68c and an outer surface 68d. In an embodiment, the connecting portion 68 is discontinuous around its circumference such that a slot 76 is provided.

In some embodiments, the connecting portion 68 has a plurality of spaced apart nubs 78 extending from the second end 68b thereof. In an embodiment, the nubs 78 extend in a longitudinal direction parallel to the centerline 76. Each nub 78 has a length which is substantially less than the length of the connecting portion 68. In an embodiment, the nubs 78 extend in the same plane as the connecting portion 68. In an embodiment, the nubs 78 have a curved profile which matches the curved profile of the connecting portion 68.

In some embodiments, the connecting portion 68 has a plurality of spaced apart dimples or protrusions 80a, 80b provided thereon. In an embodiment, the protrusions 80a, 80b are formed as spherical domes. In an embodiment, the protrusions 80a, 80b are elongated. The protrusions 80a, 80b may be aligned around the circumference of the connecting portion 68. The protrusions 80a, 80b may alternate between a protrusion 80a extending outwardly from the outer surface 68d of the connecting portion 68 and a protrusion 80b extending inwardly from the inner surface 68c of the connecting portion 68. Other patterns of outwardly extending protrusions 80a and inwardly extending protrusion 80b may be provided around the circumference of the connecting portion 68. The number of protrusions 80a extending outwardly may differ from the number of protrusions 80b extending inwardly.

The beams 70 extend from the first end 68a of the connecting portion 68. Each beam 70 is parallel to, and radially spaced from, the centerline 74. The beams 70 are spaced apart from each other around the circumference of the connecting portion 68.

In an embodiment, each beam 70 has a first portion 82 which extends at an angle from the connecting portion 68 at a corner 84, and a second portion 86 which extends at an angle from an end of the first portion 82 at a corner 88. The first portion 82 angles inwardly toward the centerline 74, and the second portion 86 angles outwardly from the centerline 74. The corners 88 may be radiused. In an embodiment, the corners 88 are aligned around the circumference of the contact 52 and define an inner diameter. The inner diameter defined by the corners 88 is less than the diameter of the pin 200.

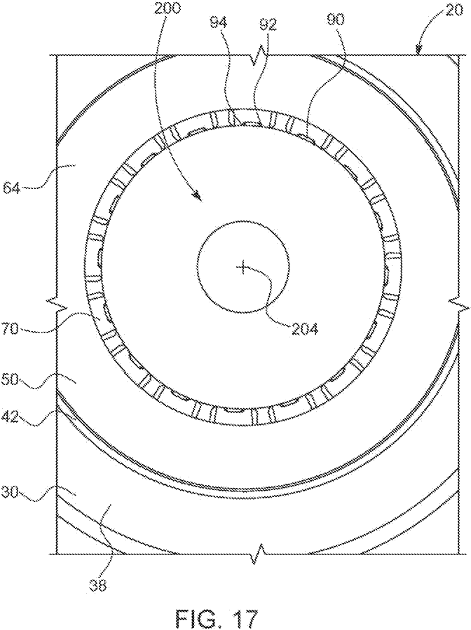

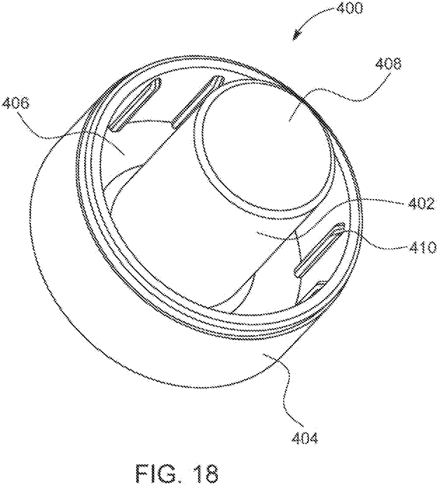

In an embodiment, each beam 70 has a recess 90 along its inner surface 70c which is spaced from the free end 86a of the second portion 84. The recess 90 has elongated side edges 92, 94 which extend parallel to the centerline 74 of the contact 52 and end edges 96, 98 at the opposite ends of the side edges 92, 94. The recess 90 extends along a section of the first portion 82, along the corner 84 and along a section of the second portion 88. The recess 90 allows the circumference of the body 202 of the pin 200 to be accommodated therein to provide two points of contact with each beam 70 as shown in FIG. 17.

The contact 52 may be stamped out of a flat sheet of material and rolled into the shape. The contact 52 may be machined into the shape.

In an embodiment as shown in FIGS. 7, 9 and 10, the cap 54 has an annular first wall 100 which defines a central passageway 102, and a second wall 104 extending radially outwardly from and perpendicular to the first wall 100. In an embodiment, the cap 54 additionally has an annular third wall 106, see FIG. 8, extending from and perpendicular to the second wall 104 and generally parallel to the first wall 100.

The contact 52 is seated within the passageway 60 of the barrel 50 such that the second end 52a of the contact 52 generally aligns with the second end 50b of the barrel 50, the first end of the contact 52 is spaced from the first end 50a of the barrel 50, and the centerlines 62, 74 align. The outer surface 68d of the connecting portion 68 is proximate to the inner surface 56d of the wall 56 of the barrel 50 and the outwardly extending protrusions 80a abut against the inner surface 56d of the wall 56. The cap 54 secures the barrel 50 and the contact 52 together. In an embodiment, the cap 54 is press fit to the barrel 50 and contact 52. In an embodiment, the cap 54 is crimped to the barrel 50 and contact 52. The wall 100 of the cap 54 engages against the inwardly extending protrusions 80a of the barrel 50. The wall 100 of the cap 54 has a diameter which is less than a diameter defined by the inwardly extending protrusions 80a. Therefore, when the wall 100 of the cap 54 is engaged with the connecting portion 68, the protrusions 80a, 80b are deformed. The wall 104 engages the end 56b of the wall 56 of the barrel 50. In some embodiments, the ends of the nubs 78 engage against the wall 104 and form electrical paths. In the embodiment of the cap 54 which includes the wall 106, the wall 106 engages with the flange 66. In some embodiments, the flange 66 seats within a recess in the wall 106.

In an embodiment, the biasing member(s) 34 are wave springs. In an embodiment, the biasing member(s) 34 are spring washers. In an embodiment, the biasing member(s) 34 are thrust washers.

The contact assembly 32 seats within the base 30. The wall 56 of the barrel 50 seats within the passageway 42 of the base 30. The wall 56 extends outwardly from the ends 30a, 30b of the base 30. The flange 58 of the barrel 50 seats within the channel 46 of the base 30 and extends into the passageway 42 of the base 30. The contact assembly 32 can be seated such that the first end 56a of the wall 56 is proximate to the wall 38 of the base 30 or such that the second end 56b of the wall 56 is proximate to the wall 38 of the base 30. The wall 56 has a diameter which is less than the passageway 42 of the base 30 and the flange 58 is smaller than the channel 46 of the base 30 but has a diameter which is greater than the passageway 42 of the base 30. As a result, the contact assembly 32 can move relative to the base 30, but cannot be pulled outwardly from the first end 30a of the base 30.

When the barrel 50 shown in FIGS. 7-9 is used, in an embodiment, a first biasing member 34 is seated between, and abuts, the flange 58 and the first wall 38 and further surrounds the wall 56 of the barrel 50, and a second biasing member 34 is seated between, and abuts, the flange 58 and the second wall 40 and further surrounds the wall 56 of the barrel 50. In an embodiment, only the first biasing member 34 is provided and the flange 58 engages the second wall 40. In an embodiment, only the second biasing member 34 is provided and the flange 58 engages the first wall 38. The socket connector 20 of this embodiment is mounted to the component 300 either by a surface mount or by press fitting the socketing connector 20 into the through hole 302. When surface mounted, either the first wall 38 or the second wall 40 of the base 30 is affixed to the component 300, such as, for example, by soldering the base 30 to a conductive trace on component 300, and the wall 56 of the barrel 50 seats within the through hole 302 of the component 300. The wall 56 of the barrel 50 has a diameter which is less than the diameter of the through hole 302. When press fit, the outer surface 36d of the wall 36 of the base 30 engages the wall forming the through hole 302 of the component 300; the through hole 302 is plated to provide an electrical connection to the conductive trace on the component 300. When press fit, the lip 48 prevents the further movement of the socket connector 20 into the through hole 302. If serrations are provided on the wall 36, the serrations bite into the wall forming the through hole 302. As a result, the contact assembly 32 can move relative to the base 30 and relative to the component 300, but the base 30 cannot move relative to the component 300.

When the barrel 50 shown in FIG. 10 is used, in an embodiment, a first biasing member 34 is seated between, and abuts, the flange 58 and the first wall 38 and further surrounds the wall 56 of the barrel 50, and a second biasing member 34 abuts the opposite side of the flange 58 and surrounds the wall 56 of the barrel 50. When mounted to the component 300 as described herein, the second biasing member 34 engages against the surface 300a of the component 300. In an embodiment, only the first biasing member 34 is provided and the flange 58 engages the surface 300a of the component 300. In an embodiment, only the second biasing member 34 is provided and the flange 58 engages the first wall 38. The socket connector 20 of this embodiment can only be surface mounted to the component 300. The second wall 40 of the base 30 is affixed to the component 300, such as, for example, by welding, and the wall 56 of the barrel 50 seats within the through hole 302 of the component 300. The wall 56 of the barrel 50 has a diameter which is less than the diameter of the through hole 302. As a result, the contact assembly 32 can move relative to the base 30 and relative to the component 300.

The pin 200 can be inserted into the contact 52 from either direction. That is, the pin 200 can be inserted into the contact 52 such that the pin 200 first passes the connecting portion 68 and then engages with the corners 88 of the contact 52, or the pin 200 can be inserted into the contact 52 such that the pin 200 first passes the free ends 86a of the beams 70 and then engages with the corners 88 of the contact 52. When the pin 200 engages with the corners 88 of the contact 52, the beams 70 flex and generally straighten. The outwardly turned ends 86a of the second portions 86 may contact the inner surface 56c of the wall 56 of the barrel 50. Electrical signals flow from the pin 200, through the beams 70, through the connecting portion 68, though the barrel 50 and the cap 54, through the biasing member(s) 34, through the base 30 to the component 300.

The flange 58 of the barrel 50 can translate in a radial direction and rotate within the channel 46 of the base 30. The biasing member(s) 34 bias the flange 58 against the opposing wall 38, 40 of the barrel 50 to maintain electrical contact between the flange 58 and the base 30, and consequently with the contact 52. Since the contact assembly 32 can move relative to the base 30, a certain degree of misalignment between the socket connector 20 and the pin 200 is automatically compensated for, while maintaining electrical contact. When misaligned, the centerline 204 of the pin 22 does not align with the centerline 44 of the base 30 during insertion. If there is misalignment, the contact assembly 32 moves or floats by the flange 58 engaging with the biasing member(s) 34 to compress the biasing member(s) 34.

In this regard, if two biasing members 34 are provided in the form of springs, the springs may have different spring characteristics to provide for a stiffer spring and a softer spring. The softer spring deflects first to provide tolerance and after the softer spring is deflected, the stronger spring deflects to provide tolerance. For example, if wave springs are provided, one wave spring may have more waves than the other wave spring. For example, one wave spring may have twelve waves, while the other wave spring has six waves. In a preferred embodiment, the stiffer spring has double the waves of the softer spring.

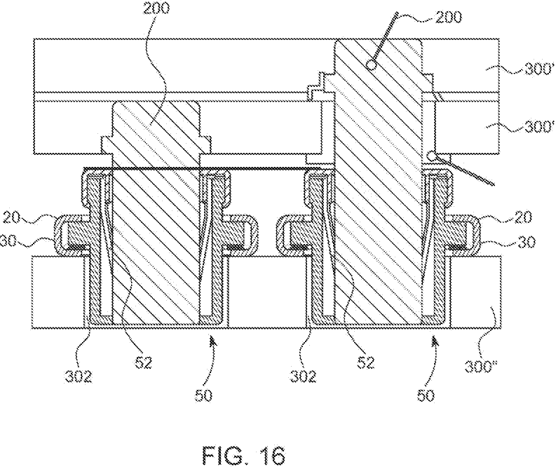

An example of an implementation of the socket connector 20 with connector 300 is shown in FIG. 16. In FIG. 16, a pair of bus bars 300′ and a printed circuit board 300″ are provided. Each pin 200 is secured to a respective one of the bus bars 300′ and is electrically isolated from the other one of the respective bus bars 300′. Each pin 200 is received in a respective socket connector 20 mounted on the printed circuit board 300″ and makes electrical contact with the socket connector 20 as described herein. The contact assembly 32 moves relative to the base 30 to compensate for any tolerance stack. Movement resulting from expansion caused by the generation of heat can also be absorbed by the float between the contact assembly 32 and the base 30.

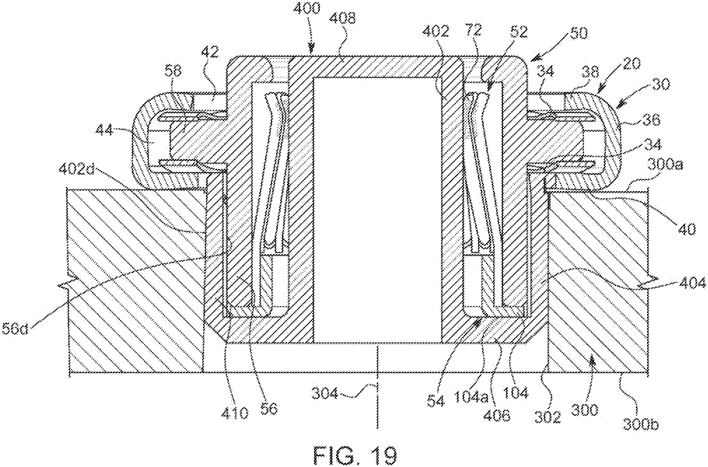

To facilitate surface mounting of the socket connector 20 to the component 300, an alignment tool 400, see FIG. 18, is utilized. The alignment tool 400 includes an inner cylindrical wall 402, an outer cylindrical wall 404 and a base wall 406 which spaces the inner cylindrical wall 402 from the outer cylindrical wall 404. The inner and outer walls 402, 404 are parallel to each other and extend in the same direction from the base wall 406. An end of the inner cylindrical wall 402 may be closed by a wall 408. The outer cylindrical wall 404 has a plurality of fingers 410 extending from an inner surface of the outer wall 404. In use as shown in FIG. 19, the socket connector 20 is disposed on the alignment tool 400 such that the inner cylindrical wall 402 seats within the passageway 72 of the contact 52, the base 406 engages a second end 104b of the wall 104 of the cap 54, and the fingers 410 on the outer cylindrical wall 404 engage the outer surface 56d of the wall 56 of the barrel 50 and extends into the passageway 42 of the base 30. Thereafter, the assembled socket connector 20 and alignment tool 400 are seated within the through hole 302 in the component 300 until the wall 38 or 40 of the base 30 which is being surface mounted to the component 300 engages with the surface 300a of the component 300. The outer cylindrical wall 404 is sized to be slightly smaller than the through hole 302 such that an outer surface 402d of the outer cylindrical wall 404 engages the wall forming the through hole 302 in the component 300. After the wall 38 or 40 of the base 30 is surface mounted to the component 300, the aligned centerlines 62, 74 of the barrel 50 and the contact 52 align with the centerline 304 of the component 300. After the socket connector 20 is surface mounted to the component 300, the alignment tool 400 is removed from the socket connector 20 by pulling the alignment tool 400 out of the other side of the through hole 302.

The use of the terms “a” and “an” and “the” and “at least one” and similar references in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A socket connector configured to mount to an electrical component comprising:
a base having an outer wall, a first wall extending inwardly from the outer wall, and a second wall extending inwardly from the outer wall, wherein inner surfaces of the first and second walls form a generally cylindrical passageway which extends between, and is open to, first and second ends of the base, wherein inner surfaces of the outer wall, the first wall and the second wall form an channel which is in communication with and extends outwardly from the passageway, wherein the base is a one-piece construction;
a barrel including an annular wall having opposite ends, a passageway extending between the opposite ends of the annular wall of the barrel, and a flange extending outwardly from the annular wall of the barrel, the annular wall of the barrel having a diameter which is less than a diameter of the passageway of the base, the annular wall of the barrel being positioned within the passageway of the base and the flange being positioned within the channel of the base, and wherein the barrel is configured for movement within the base; and
a biasing member provided between, and in contact with, the flange and one of the first and second walls of the base.

2. The socket connector of claim 1, wherein the flange is annular.

3. The socket connector of claim 2, wherein the barrel is a one-piece construction.

4. The socket connector of claim 1, wherein the barrel is a one-piece construction.

5. The socket connector of claim 1, wherein the biasing member defines a first biasing member between, and in contact with, a first surface of the flange and the first wall of the base, and further comprising a second biasing member provided between, and in contact with, a second opposite surface of the flange and the second wall of the base.

6. The socket connector of claim 1, wherein the base and the barrel are conductive.

7. The socket connector of claim 1, further comprising a contact seated within the passageway of the barrel.

8. The socket connector of claim 7, further comprising a cap coupling the contact and the barrel together.

9. The socket connector of claim 8, wherein the base, the barrel, the contact and the cap are conductive.

10. The socket connector of claim 1, wherein the biasing member surrounds the wall of the barrel.

11. The socket connector of claim 1, wherein the outer wall and the first wall are perpendicular to each other.

12. The socket connector of claim 1, wherein the outer wall and the first wall are perpendicular to each other, and the outer wall and the second wall are perpendicular to each other.

13. The socket connector of claim 1, wherein the first and second walls are parallel to each other.

14. The socket connector of claim 1, wherein the annular wall of the barrel extends outwardly from the first end of the base.

15. The socket connector of claim 1, wherein the annular wall of the barrel extends outwardly from the first end of the base and from the second end of the base.

16. The socket connector of claim 1, wherein the biasing member is a wave spring.

17. The socket connector of claim 1, wherein an outer surface of the outer wall of the barrel is serrated.

18. The socket connector of claim 1, wherein the outer wall and the first and second walls have a generally U-shaped cross-section.

19. The socket connector of claim 1, wherein the annular wall of the barrel defines a circular cross-section.
